(19) United States
(12) Patent Application Publication
(10) Pub. No.: US 2007/0027410 A1
(43) Pub. Date: Feb. 1, 2007

(54) Continuous passive and active motion machine for the ankle

(76) Inventor: Jay Alan Cost, San Clemente, CA (US)

Correspondence Address: Micah Goldsmith, 75 Kyle Ct, Mission Viejo, CA, 92694, US

(21) Appl. No.: 11/192,086

(22) Filed: Jul. 29, 2005

(51) Int. Cl. A61H 1/00

(52) U.S. Cl. 601/5; 601/24; 601/27

(57) ABSTRACT

The present invention is a continuous passive and active motion machine for the ankle. The invention includes a base configured to be placed on a flat, stable surface. The base is connected to a foot plate portion, which is connected to a drive shaft mechanism that moves along glide tracks using a motor. The foot plate is caused to move in a direction substantially perpendicular to movement of the drive shaft mechanism. Pressure sensors are added to provide feedback data to a controller. The controller potentially alters the behavior of the machine based on the provided feedback data.

### BACKGROUND OF THE INVENTION

1. Field of the Invention

This invention relates generally to an apparatus for applying continuous passive and active motion to a human joint, and more particularly to a system that operates on the ankle.

2. Description of the Prior Art

“Continuous Passive Motion” (CPM) is the concept of applying controlled, continuous movement to joints following joint injury or surgery. Machines have been developed to assist in the rehabilitative therapist's ability to apply CPM to patients. Different machines were designed for different joints. One machine was developed where a patient was able to perform dorsi-flexion and plantar-flexion on the ankle.

The machine worked as shown in FIG. 1, the patient 100 lies in a bed 110. A brace 120 is used to make the knee 130 more or less stationary. Brace 120 might include straps above and/or below the knee to better secure the joint. Foot plate 140 has a hinging mechanism 150 that allows the foot plate 140 to move backwards and forwards as shown by arrow 160. By moving foot plate 140 back and forth in a slow and controlled cycle, the patient 100 can passively perform dorsi-flexion and plantar-flexion, which assists the patient in recovering from their injury.

Neuro-muscular conditions such a Parkinson's disease, stroke, and traumatic brain injury may affect the lower extremities. In these cases and others, the machine can be dangerous because it may apply too much force to the lower extremities, for instance the ankle. This can occur, for example, when the patient has rigidity, which might mean that at one or both of the ends of their range of motion using a CPM machine are causing a pressure on the joint that exceeds a threshold that is recognized as being safe. Moreover, a temporary condition, such as spasticity might make use of the machine dangerous in general and motion should be discontinued or temporarily stopped. What is needed is a machine that can respond to such conditions and not cause harm to the patient.

### SUMMARY OF THE INVENTION

The present invention is a continuous passive and active motion machine for the ankle. It includes a base configured to be placed on a stable surface. The base is connected to a foot plate that in turn is connected to a hinging mechanism. The hinging mechanism allows the foot plate to move back and forth between a first and a second position to perform dorsi-flexion and plantar-flexion on the ankle. The patient's knee remains essentially stationary as the ankle undergoes CPM.

A pressure sensor, such as a pressure plate, can be added to the foot plate to measure the force being applied to the foot. A bi-directional connection is implemented between a motor in the CPM machine and a controller creating a feedback loop. The feedback loop operates by the pressure sensor continuously providing input data to the controller and the controller providing instructions to the motor to modify the behavior of the machine, if necessary.

The controller portion of the present invention includes a kill switch, to immediately disengage the hinging mechanism in case of emergency. The controller also includes a general purpose computing device comprising at least a processor, a memory, and an input/output capability attached to the CPM machine. The memory of the computing device stores computer software, firmware, or both containing instructions for the operation of the machine. Such instructions comprise computer programs that have the capability to cause the machine to, for instance, move in defined ranges of motions for certain periods of time, and at certain speeds, while pausing for certain periods at the ends of the range of motion.

The input capability of the computing device allows for the input of pre-defined parameters, which directs the machine how to move. Alternatively, the machine can be controlled manually. The machine may also be caused to disengage and allow the patient to take advantage of continuous active motion (CAM) or it can be caused to resist the motion of the patient to perform a therapeutic strengthening exercise.

One embodiment of the present invention includes one or more pressure sensors, such as pressure strips, that are connected to straps that help affix the patient's foot to the foot plate. The pressure sensors can be used in a feedback loop with the controller to determine the strength of dorsi-flexion while the machine operates and to make adjustments if necessary.

### BRIEF DESCRIPTION OF THE DRAWINGS

The invention has been generally described and it will now be referred to in more detail by reference to the accompanying drawings, illustrating in which:

FIG. 1 is an example of a prior art continuous passive motion machine;

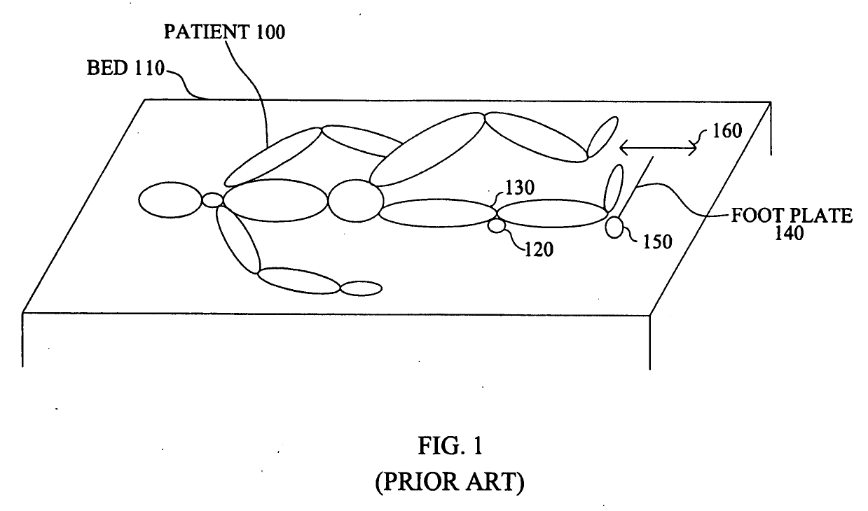

FIG. 2 is an example of a continuous passive and active motion machine according to an embodiment of the present invention in a first mode of operation;

FIG. 3 shows a detailed description of a hinging mechanism according to one embodiment of the present invention.

FIG. 4 is an example of a continuous passive and active motion machine according to an embodiment of the present invention including a pressure sensor;

FIG. 5 is a computer controller according to an embodiment of the present invention.

FIG. 6 is a flowchart showing the operation of an embodiment of the present invention.

FIG. 7 is flowchart showing the operation of another embodiment of the present invention.

FIG. 8 is flowchart showing the operation of another embodiment of the present invention.

FIG. 9 is a diagram of an embodiment of the present invention that uses pressure sensors.

FIG. 10 is a flowchart showing a feedback loop that uses pressure sensors according to an embodiment of the present invention.

### DETAILED DESCRIPTION OF THE INVENTION

The present invention is a continuous passive and active motion machine for the ankle. The system is operated by causing the machine to be movable along a hinging mechanism connected to a foot plate. The patient's knee remains essentially stationary, while their ankle undergoes dorsi-flexion and plantar-flexion.

Continuous Passive and Active Motion Machine for the Ankle

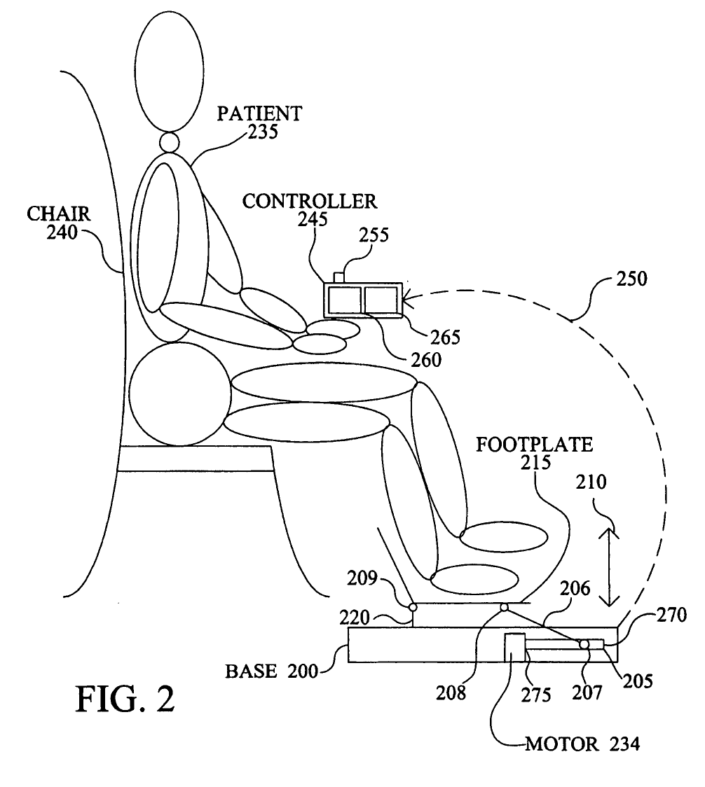

An embodiment of the present invention is shown in connection with FIG. 2. Base 200 includes a glide track 205. Foot plate 215 is connected to support 220, which in turn is connected to base 200. Foot plate 215 is also connected to glide track 205 with a rod 206. Rod 206 has movable hinges 207 and 208 that allow rod 206 to move between a first end 275 and a second end 270 of glide track 205, for instance using a motor or hydraulic mechanism.

Foot plate 215 is thus moved in the directions of arrow 210 as hinging mechanism 209 connected to support 220 moves. Support 220 is affixed to base 200. The motion of foot plate 215, in general, is designed to achieve inversion and eversion which occurs when there is dorsi-flexion and plantar flexion of the foot, wherein dorsi-flexion is achieved when the toes and distal portion of the foot are pointed substantially upward and plantar-flexion is achieved when the toes and distal portion of the foot are pointed substantially downward.

Patient 235 sits in chair 240 and places their ankle in foot plate 215. Patient 235 holds controller 245, which is connected to a motor 234 via bi-directional connection 250, which controls the motion along glide track 205. Connection 250 includes any known to those skilled in the art including a wired or wireless connection. Controller 245 includes a kill switch 255 to disable and disengage the system immediately if necessary. Controller 245 also includes input area 260 and output area 265, which may be a keyboard and screen respectively, for instance.

The patient or therapist utilizes input area 260, by providing instructions to the controller 245. Controller 245 executes the instructions. For instance, parameters may be provided that include speed, range of motion, whether to pause at the end of the range of motion, how long to pause at the end of the range of motion, variations in speed that are appropriate for the patient's level of flexibility, and pressure thresholds on the patient's joints that should not be exceeded.

Once loaded, the program executes by moving foot plate 215 in the direction of arrows 210 by moving back and forth between first and second ends of the range of motion 270 and 275 on glide track 205. Thus foot plate 215 moves in a direction that is essentially perpendicular to the motion along the glide track 205. At ends 270 and 275 a variable pause may be included. The speed at which foot plate 220 moves between ends 270 and 275 includes not only constant velocities, but also such options as variable stable speeds or ramped speeds comprising a gradual slowing or speeding up of the range of motion over time. The distance at which controller 245 allows foot plate 215 to move is based on the flexibility of the recovering patient's ankle.

Typically, without a CPM machine, the therapist will work a joint manually by beginning slowly and seeing how far the joint will stretch by slowly increasing the range of motion in a cyclical manner. When the end of the range of motion is reached, a pause is included so the joint may be stretched. The present invention reproduces these actions automatically based on the input parameters or manually as input is provided to the controller as the machine operates. Parameters, such as speed, distance of range of motion at ends 270 and 275, pause at the ends 270 and 275 of the range of motion, and ramping of speed in the direction of arrow 210 may all be provided to the controller 245 in advance or manually during a session of CPM.

The machine may also be caused to disengage and allow the patient to take advantage of continuous active motion (CAM). Similarly, the machine may be caused to resist the motion of the patient to perform a therapeutic strengthening exercise. When the session is complete, the actions of the machine are stored in the controller 245, for instance in a volatile or non-volatile memory device, and output area 265 can be utilized with a print module to print out or display on a remote or local computer, or on the controller, the actions taken by the machine, so the therapist can track the patient's progress.

Hinging Mechanism

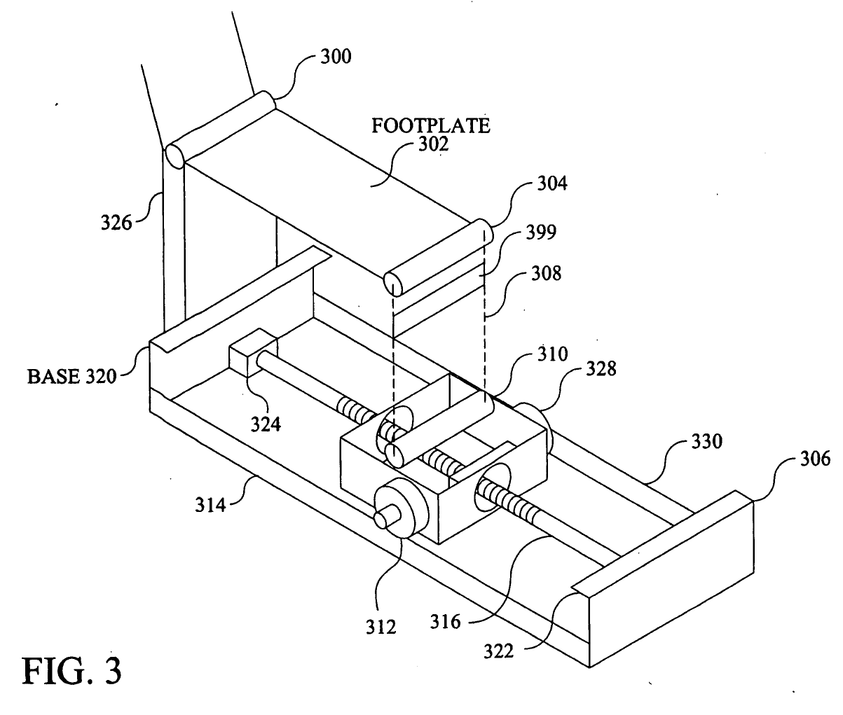

FIG. 3 shows a detailed description of a hinging mechanism according to one embodiment of the present invention. Base 320 is connected to foot plate 302 using support 326. A hinge 300 at a first end of foot plate 302 and a hinge 304 at a second end of foot plate 302 are movable wherein foot plate 302 is able to move up and down to move the patient's ankle. Hinge 304 is connected to a lower hinge 310 via rod 308. Rod 308 includes an optional adjustment 399 for inversion and eversion of the ankle. As the foot plate moves up and down, such movement is controlled by the motion of carriage member 310 back and forth between first and second ends 320 and 322 of base 320.

Carriage member 310 includes, for instance first and second wheels 312 and 328 that are movable along first and second tracks 314 and 330 as longitudinal screw 316 is rotated by motor 324. Thus a rotational motion caused in motor 324 in either direction causes screw 322 to guide carriage member 310 back and forth at different speeds and in different ranges of motion to perform CPM.

Pressure Plate

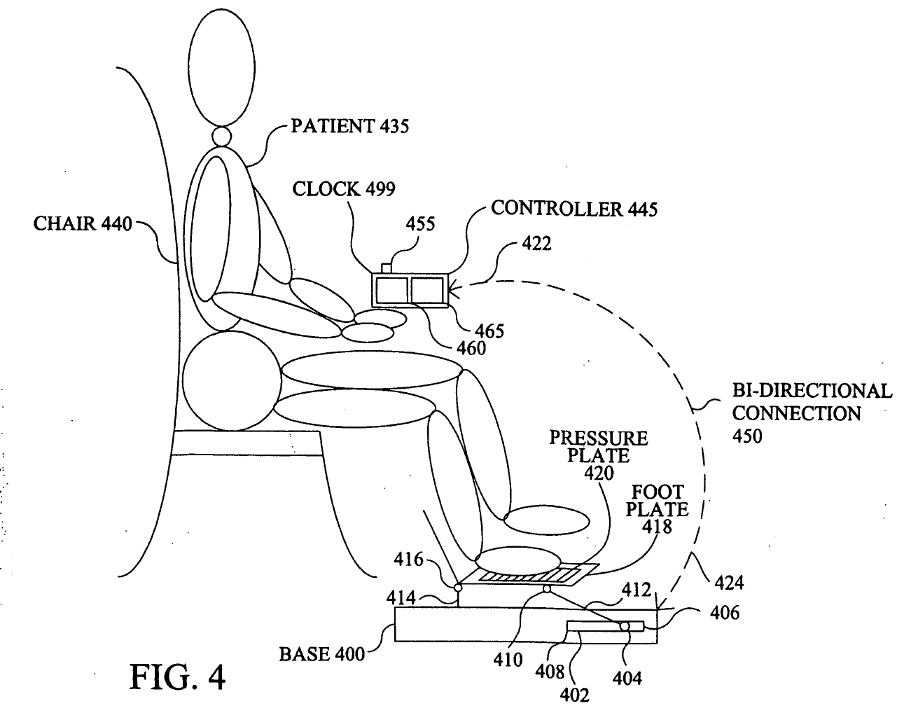

A pressure sensor, such as a pressure plate, is added to the foot plate in an embodiment of the present invention shown in FIG. 4. Base 400 includes a foot plate 418, which is connected to base 400 via support 414. Foot plate 418 is moved back and forth in an essentially up and down motion while hinging mechanisms 416, 410, and 404 provide points of rotation similar to those shown with respect to FIGS. 2 and 3, as a motor guides the system along glide track 402 between first and second ends of the range of motion 406 and 408.

Foot plate 418 is fitted with a pressure sensor 420. Pressure sensor 420 is used, for instance, to determine the force applied by the foot to the foot plate 418. A threshold for an amount of force that can safely be applied to pressure sensor 420 may be input to the system. A set maximum threshold of force indicates, for instance, that the patient 435 is performing dorsi or plantar flexion in a range that exceeds what is safe for their injured joint (this might occur, for instance because the patient's flexibility is limited or a neuro-muscular condition exists). In such a case, the machine should be disengaged, paused, reversed, slowed, have its range of motion reduced, or otherwise have its actions altered to adapt to the situation so that the patient is not injured.

Thus, when pressure sensor 420 indicates the force on the foot is beyond a set threshold, alternate instructions mimicking the therapist's actions may be loaded so the patient can safely continue CPM with a reduced risk of injury and greater therapeutic benefits. Such instructions may be provided by the therapist manually, or they may automatically occur. The alternate series of instructions includes, for instance, parameters that instruct the machine to gradually ramp down the speed of the machine, to reduce the range of motion of the activity, to reverse the machine, and/or to pause at the end of the range of motion briefly to impart a stretch.

In operation, patient 435 sits in chair 440 and places their ankle in foot plate 418. Patient 435 holds computer controller 445 (or optionally it is held by the therapist), which is connected to glide track 402 via bi-directional connection 450. Connection 450 includes any known to those skilled in the art including a wired or wireless connection. Controller 445 includes a kill switch 455 to disable and disengage the system. Controller 445 also includes input area 460 and output area 465.

The patient or therapist utilizes input area 460, for instance by giving instructions to the controller 445 or by controlling or changing the activities of the device manually. Controller 445 executes the instructions as they are received and processed. For instance, parameters may be provided for a specific patient 435 that includes a speed, range of motion, whether to pause at the end of the range of motion, how long to pause at the end of the range of motion, variations in speed that are appropriate for the patient, and pressure thresholds that the patient should not exceed 435.

Once loaded, the program executes by moving support rod 412 repeatedly back and forth between first and second ends of the range of motion 406 and 408. At positions 406 and 408 a variable pause may be included. The speed at which foot plate 418 moves, and likewise rod 412 moves in glide track 402 between ends 406 and 408 is controlled by the controller 445 in connection with the motor. The controller makes it possible to control motor in such a manner that the machine moves in constant speeds or alternatively at ramped speeds, comprising a gradual slowing or speeding up of the range of motion over time. The distance between points 406 and 408 is strictly controlled, based on the flexibility of the joint that is undergoing CPM.

Neuro-muscular conditions such a Parkinson's disease, stroke, and traumatic brain injury, for instance, may cause spasticity or rigidity in the ankle. In these cases, the pressure on foot plate 418 may exceed the threshold briefly. In such a case, the machine pauses then resumes or reverses. Such a behavior is reproduced by one embodiment of the present invention by employing a feedback loop. Bi-directional connection 450 is used to facilitate the communication of data from the CPM machine to the controller 445 (the amount of pressure applied by the patient's foot to pressure sensor 420) and from the computer controller 445 to the CPM machine.

Typically, the pressure sensor 420 will indicate that a set threshold has been exceeded. When this occurs the machine may reduce the distance between points 406 and 408 (the range of motion) until the pressure no longer exceeds the threshold, then the machine will hold briefly at the ends of the reduced range of motion, and gradually increase the range of motion until the goal is reached. Alternatively, the machine may repeat the above process one or more times, and if the full range of motion continues to cause the pressure at foot plate 420 to exceed the set threshold then the machine may disengage, or continue in a plantar-flexion/dorsi-flexion cycle.

The speed may be controlled by any method known to those skilled in the art, including a variable speed, reversible motor or a hydraulic mechanism. The ranges of motion are determined, for instance, by measuring the number of times a longitudinal screw has rotated in a drive shaft mechanism, or noting the pressure on a hydraulic drive shaft mechanism. Pauses at the end of the ranges of motion and timing of complete CPM cycles is accomplished with a clock 499. When the session is complete, the actions of the machine are stored in the controller 445, and output area 465 can be utilized with a print module to print out or display on a remote or local computer the actions taken by the machine, so the therapist can track the patient's progress.

Controller

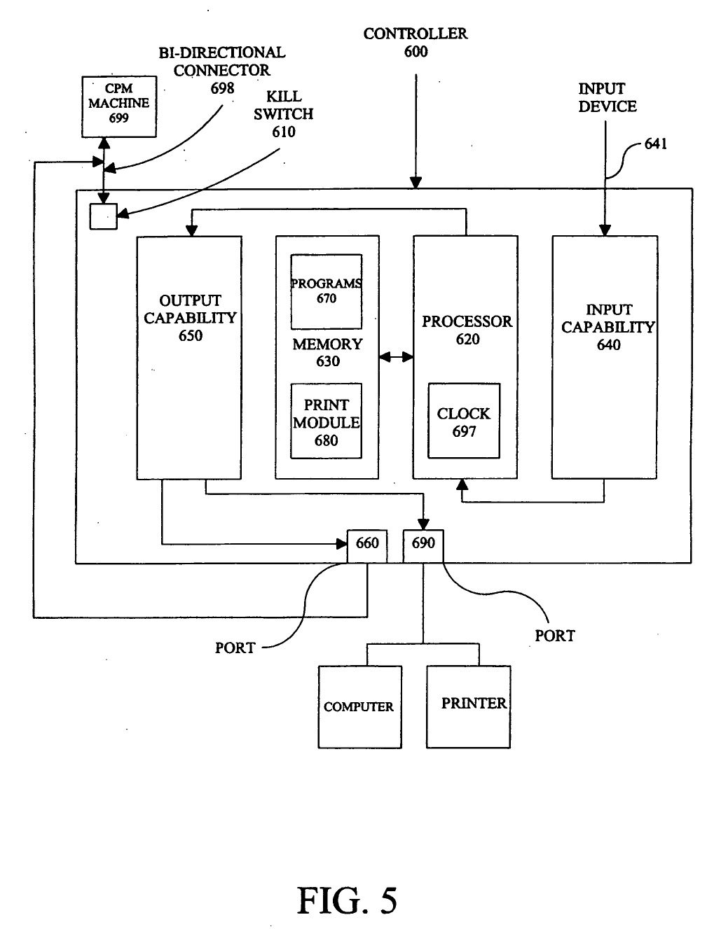

The controller portion of the present invention is shown as block 600 of FIG. 5, it includes a kill switch 610, to disengage the drive shaft mechanism immediately when necessary. The controller also includes a general purpose computing device comprising at least a processor 620, a system clock 647 coordinating the operation of the processor 620, a memory 630, an input capability 640 and an output capability 650. A port 660 facilitates a bi-directional connection to an attached CPM machine 699. Port 660 can be a wired port, an infrared port, a radio frequency port, or other port known to those skilled in the art capable of transferring data to and from the CPM machine 699.

The memory 630 of the computing device stores computer software, firmware, or both containing a plurality of instructions or computer programs 670 for the operation of the machine. Such instructions have the capability to cause the machine to, for instance, move in defined ranges of motions for certain periods of time, and at certain speeds, while pausing for certain periods at the ends of the range of motion.

The input capability 640 of the computing device allows the therapist to input pre-defined parameters for each patient by connecting to an attached or external input device along line 641. Input capability 640 includes, for instance, a keyboard, mouse, touchpad, touchscreen, stylus device, microphone, or other input device known to those skilled in the art.

In another embodiment, a print module 680 is included in the memory 630, which utilizes the output capabilities of the computing device, including an output port 690 to prepare reports, which track what the patient has previously done with the machine. The output capability 650 further includes a screen, either integrated directly into the controller or externally connected, where the therapist or user watches the progress of the use of the machine. This includes, for instance, a real time readout of the force applied at the pressure sensor.

Port 690 might include, for instance a parallel or USB port to connect to a printer 691 for a paper output, or a network or internet port capable of transferring the results to a remote or local computer for display on a display device 692, such as a monitor. Port 690 and port 660 may also be combined into a single port capable of performing the needed functions. Moreover port 690 or an additional port may be used to facilitate readings from the pressure sensor, for instance regarding the force applied to the foot plate by the patient's foot.

CPM Machine Operation

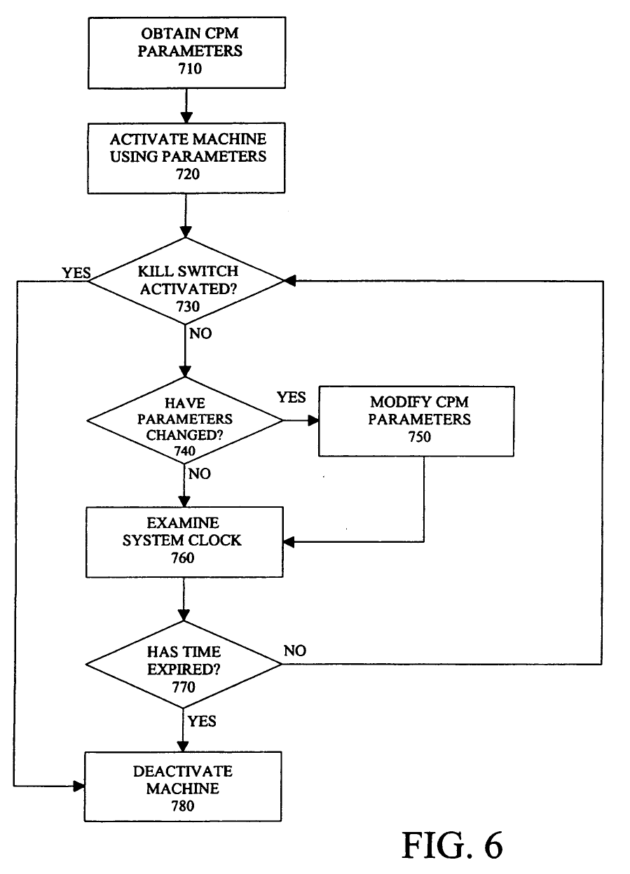

FIG. 6 is a flowchart representing the operation of an embodiment of the present invention. At block 710 CPM parameters are obtained. CPM parameters include, for instance, the location of the ends of the range of motion and the distance between the ends of the range of motion, the speed of the motion of the device, how the speeds should be ramped, if at all, if and how long of a pause should be included at the ends of the range of motion, how long the CPM cycles should repeat, etc. At block 720, CPM is initiated using the parameters obtained by activating the machine.

At block 730, it is determined if the kill switch has been activated. If not, then at block 740 it is determined if the CPM parameters have changed. If so, the CPM parameters are modified at block 750, for instance the motor is sped up, slowed down, or stopped. After block 750 or if the CPM parameters have not been changed at block 740, the system clock is examined at block 760. At block 770, it is determined whether the time for the program has expired. If so, the process ends and the machine terminates its motion at block 780. Otherwise, flow proceeds to step 730 and the process repeats until the clock indicates the session is over at block 780 or the kill switch is activated at block 730.

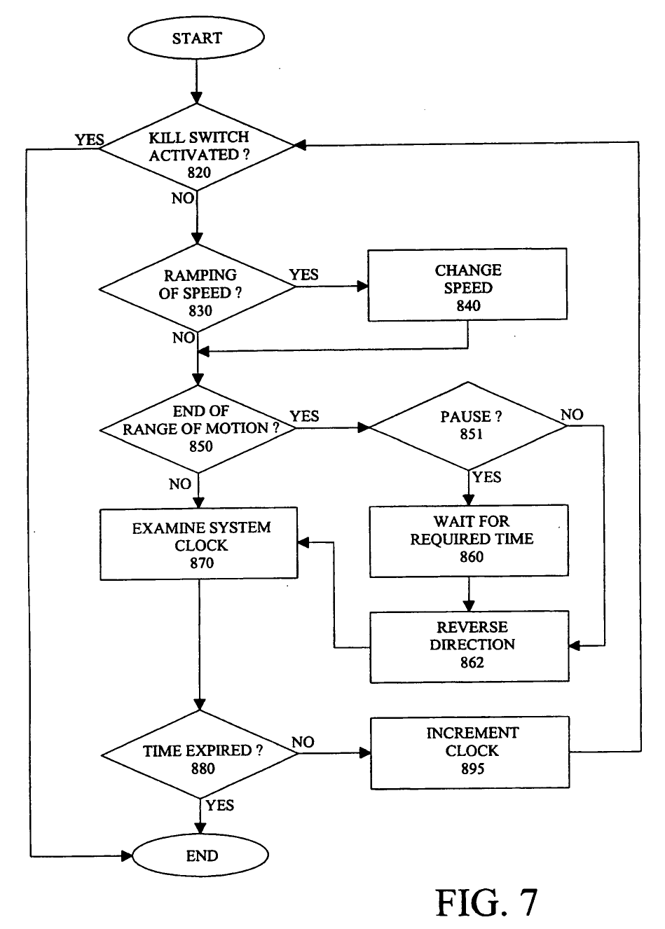

FIG. 7 is a flowchart representing the operation of another embodiment of the present invention. Initially, the machine begins CPM. At block 820, it is determined if the kill switch has been activated. If not, at block 830 it is determined if a ramping of speed is needed. If so, the speed is ramped at block 840 either by increasing or decreasing the speed of the device's motion. After ramping the speed or if none is needed, block 850 determines if it is the end of the range of motion. If so, it is determined if a pause is required at the end of the range of motion at block 851. If so, the pause is initiated at block 860, where the system waits the required amount of time as determined by the system clock. After pausing at block 860 or if no pause was needed the system reverses direction at block 862, for instance by reversing the direction of the motor.

After block 862, or if it was not the end of the range of motion at block 850, the system clock is examined at block 870. At block 880, it is determined whether the time for the program has expired. If so, CPM is ended. Otherwise, the clock is incremented at block 895 and the process repeats at block 820. If the kill switch is ever activated, the system disengages immediately.

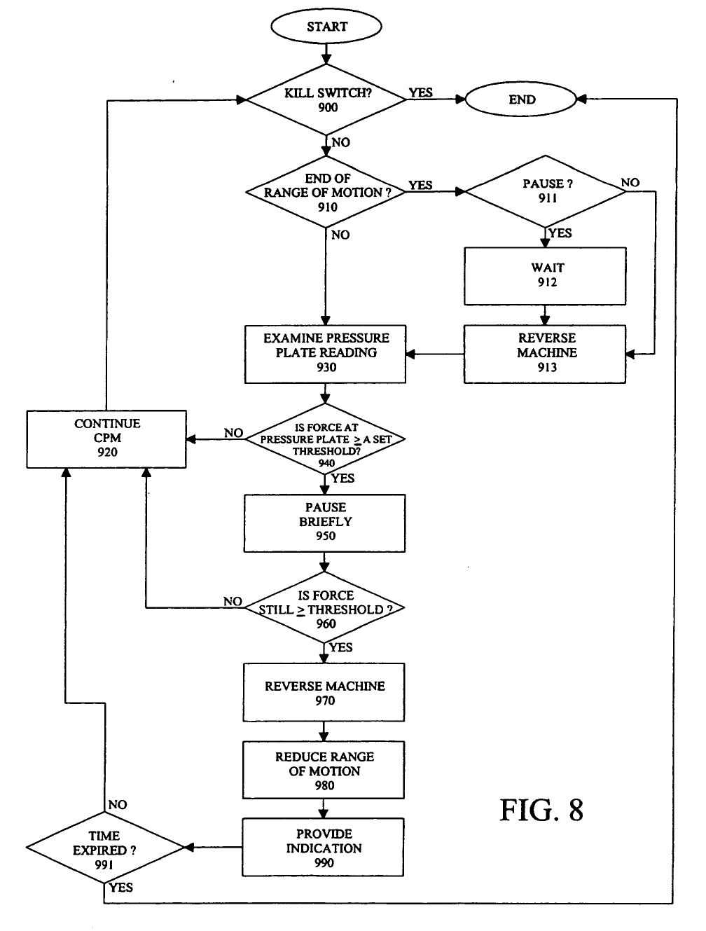

FIG. 8 is a flowchart showing an embodiment of the present invention that uses a pressure sensor and a bi-directional connection in a feedback loop. Initially, CPM cycles are started. At block 900 it is determined if the kill switch has been activated. If so, the process ends. Otherwise, at block 910, it is determined if the machine is at the end of the range of motion. If it is the end of the range of motion, it is determined at block 911 whether a pause at the end of the range of motion is required. If so, the system waits at block 912 for the required length of the pause. After waiting or if no pause is needed, the system reverses direction at block 913.

After block 913, or if it was not the end of the range of motion at block 910, the pressure sensor reading is examined at block 930. At block 940 it is determined if the force at the pressure sensor exceeds or is equal to a set threshold. If not, CPM continues at block 920 and the process repeats.

If block 940 ever becomes true, a brief pause is implemented at block 950. At block 960 it is determined if the force at the pressure sensor still exceeds or is equal to the set threshold. If not (for instance a temporary spasm or other neuro-muscular condition) caused the reading to fluctuate briefly at the pressure sensor, then flow proceeds to block 920 and the process continues. Otherwise, the machine reverses at block 970, reduces the range of motion at block 980, and an indication of the event is given at block 990. The indication includes, for instance, notifying the therapist or giving a visual or audible queue on the controller, like a flashing light or a beep. At block 991, it is determined if the time for the CPM activity has expired. If not, the process repeats at block 920. Otherwise, the process ends.

Pressure Strips

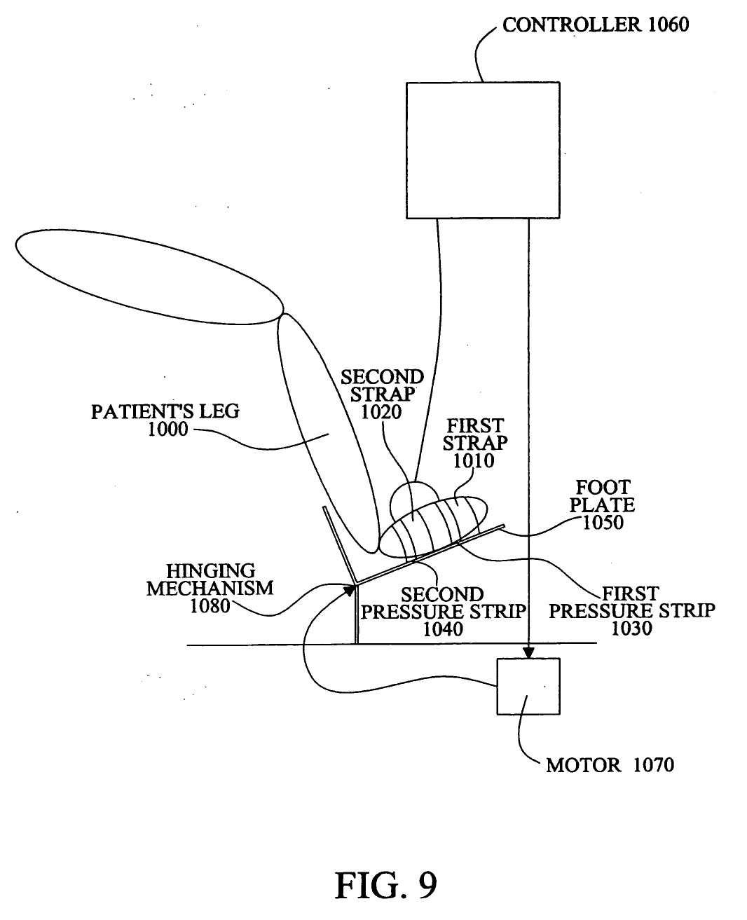

Pressure sensors, such as pressure strips, are used by an embodiment of the present invention to determine an amount of force that occurs during dorsi-flexion. According to one embodiment of the present invention, pressure sensors are provided in conjunction with one or more straps on the foot plate that is used to affix the patient's foot to the CPM machine. FIG. 9 is a diagram of an embodiment of the present invention that uses pressure sensors.

In FIG. 9, a patient's leg 1000 is positioned so that their foot is in foot plate 1050 and secured by straps 1010 and 1020. A first and second pressure sensor 1030 and 1040 are added to the straps 1010 and 1020. It should be noted that this example includes two straps and two pressure sensors, but any number of straps and pressure sensors may be used. A controller 1060 receives input from pressure sensors 1030 and 1040 regarding the amount of pressure the top of the foot is applying to the straps (dorsi-flexion).

The pressure readings provided from pressure sensors 1030 and 1040 to controller 1060 are used in controller and if a threshold is equaled or exceeded (i.e., the pressure of dorsi-flexion becomes too great), the controlled can output a signal to motor 1070, which is coupled to hinging mechanism 1080. Motor 1070 can cause hinging mechanism 1080, for instance, to lower the angle of foot plate 1050 until the pressure at pressure sensors 1030 and 1040 is within an acceptable range again. It should be noted that pressure plates and pressure strips may be used together or separate by various embodiments of the present invention.

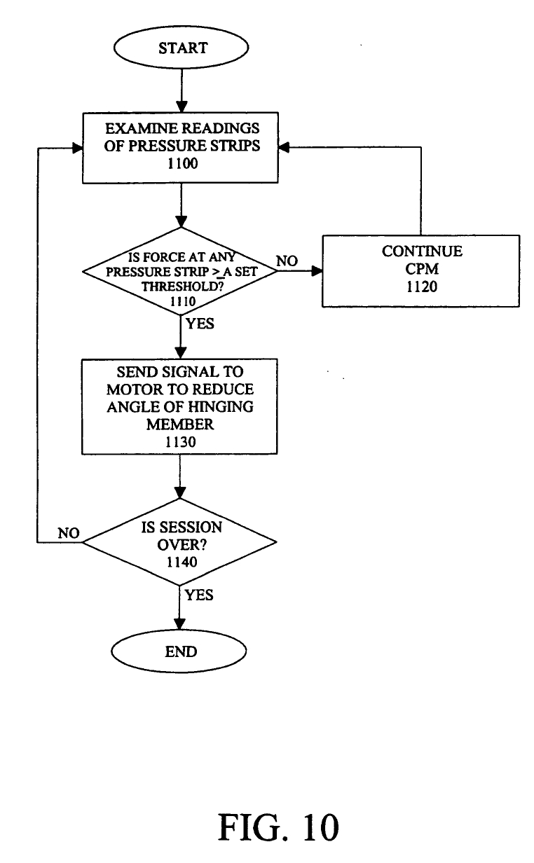

FIG. 10 is a flowchart showing a feedback loop that uses pressure strips according to an embodiment of the present invention. Initially CPM begins and the foot plate is positioned so that the patient's toes are pointed substantially upward (dorsi-flexion). At block 1100, the readings of the pressure strips are examined. At block 1110, it is determined if the force at any pressure strip is greater than or equal to a set threshold. If not, CPM continues at block 1120 and the process repeats.

Otherwise, a signal is sent at block 1130 from the controller to a motor coupled to a hinging member in the foot plate, instructing the motor to reduce the angle of the foot plate, and thereby reduce the angle of dorsi-flexion. At block 1140 it is determined if the session is over, for instance, has the session timed out or has the kill switch been activated. If not, block 1100 repeats. Otherwise, the process ends.

Plantar-flexion and dorsi-flexion pressure sensors (e.g., pressure strips or a pressure plate) may alternatively be used, whereby the motor is inactive and the pressure sensors simply monitor the patient's active strength as a quantifiable force placed on the pressure sensors. Although the description above contains many specificities, these should not be construed as limiting the scope of the invention but as merely providing illustrations of some of the presently preferred embodiments of this invention. Thus the scope of this invention should be determined by the appended claims and their legal equivalents.

What is claimed is:

1. A continuous passive motion apparatus comprising:
a base;
a foot plate connected to a support at a hinging mechanism, said support, connected to said base, wherein said foot plate is configured to move in a direction substantially perpendicular to a motion of a drive shaft mechanism along a glide track on said base;
a controller, including a kill switch to disengage a motor in said drive shaft mechanism, said controller further comprising a plurality of instructions for controlling said motor in said drive shaft mechanism; and
a pressure sensor connected to said foot plate, said pressure plate capable of sending data to said controller.

2. The apparatus of claim 1, wherein said instructions include information controlling a range of motion in said drive shaft mechanism.

3. The apparatus of claim 1, wherein said instructions include information controlling a speed in said drive shaft mechanism.

4. The apparatus of claim 1, wherein said instructions include information controlling a pause at a first and a second end of a range of motion in said drive shaft mechanism.

5. The apparatus of claim 3, wherein said speed is capable of gradually increasing over time.

6. The apparatus of claim 3, wherein said speed is capable of gradually decreasing over time.

7. The apparatus of claim 1, wherein said controller further comprises:
an output area connected to a print module in a memory of said controller, said output area including a port for providing data to an output device relating to one or more actions of said drive shaft mechanism.

8. The apparatus of claim 1, wherein said controller further comprises:
a clock configured to be incremented in time, wherein said clock is used to determine an end to said plurality of instructions.

9. The apparatus of claim 1 wherein said data from said pressure sensor comprises an amount of pressure applied to said foot plate.

10. The apparatus of claim 9 wherein said controller uses said data and compares it to a set threshold.

11. A computer program product comprising:
a computer usable medium having computer readable program code means embodied therein for causing a computer to perform continuous passive motion, comprising,
computer readable program code means for causing a computer to move a foot plate in a direction substantially perpendicular to a motion of a drive shaft mechanism along a glide track on a base, said foot plate connected to a support at a hinging mechanism, said support, connected to said base;
computer readable program code means for causing a computer to control or disengage a motor in said drive shaft mechanism; and
computer readable program code means for causing a computer to determine an amount of pressure on said foot plate.

12. The computer program product of claim 11 further comprising computer readable program code means for causing a computer to control a range of motion in said drive shaft mechanism.

13. The computer program product of claim 11 further comprising computer readable program code means for causing a computer to control a speed in said drive shaft mechanism.

14. The computer program product of claim 11 further comprising computer readable program code means for causing a computer to control a pause at a first and a second end of a range of motion in said drive shaft mechanism.

15. The computer program product of claim 11 wherein said speed is capable of gradually increasing over time.

16. The computer program product of claim 14, wherein said speed is capable of gradually decreasing over time.

17. The computer program product of claim 11, further comprising:
computer readable program code means for causing a computer to use a port for provide data to an output device relating to one or more actions of said drive shaft mechanism.

18. The computer program product of claim 11, further comprising:
computer readable program code means for causing a computer to control a clock configured to be incremented in time, wherein said clock is used to disengage said drive shaft mechanism at a certain time.

19. A continuous passive motion apparatus comprising:
a base;
a foot plate connected to a support at a hinging mechanism, said support, connected to said base, wherein said foot plate is configured to move in a direction substantially perpendicular to a motion of a drive shaft mechanism along a glide track on said base;
a controller, including a kill switch to disengage a motor in said drive shaft mechanism, said controller further comprising a plurality of instructions for controlling said motor in said drive shaft mechanism; and
one or more pressure sensors connected to one or more straps connected to said foot plate, said pressure sensors capable of sending data to said controller.
